(19) United States
(12) Patent Application Publication
(10) Pub. No.: US 2003/0030620 A1
(43) Pub. Date: Feb. 13, 2003

(54) Adjustable display device

(75) Inventors: Travis Baldwin, Raleigh, NC (US); David Wayne Hill, Cary, NC (US); Richard Sapper, Stuttgart (DE); Julie Elaine Tierney, Renfrew (GB)

Correspondence Address: SAWYER LAW GROUP, P.O. Box 51418, Palo Alto, CA, 94303, US

(73) Assignee: International Business Machines Corporation, Armonk, NY (US)

(21) Appl. No.: 09/924,877

(22) Filed: Aug. 8, 2001

(51) Int. Cl. G09G 5/00

(52) U.S. Cl. 345/156

(57) ABSTRACT

A display device comprising a display screen and a pivoting system coupled to the display device is disclosed. The pivoting system allows for rotation of the display screen from portrait to landscape; and for flipping the display from front to back, and for the display device to be folded into a compact form. The design in accordance with the present invention offers a range of freedom of movement not available with previous conventional designs. In a preferred embodiment, the display device 100 can be lifted approximately 130 mm from a flat folded position. A user can rotate the display 90° degrees from portrait through landscape orientations. A user can also flip the display 180° from front to back, which will allow users on opposite sides of a desk to view the same image without turning the display around. All of these features may be used in combination, allowing the user to take advantage of multiple positioning options.

### FIELD OF THE INVENTION

The present invention relates to a display device and more particularly to a display device which may be user-adjusted for height and viewing angle while also allowing the screen to be folded to a minimal height for storage and shipping purposes.

### BACKGROUND OF THE INVENTION

Today, display devices such as thin film transistor (TFT) or LCD displays offer limited adjustability for users. Display devices such as TFTs are also presented to users in a traditional design and configuration, similar to the older cathode ray tube (CRT) displays. Typically TFT and similar display units are much lighter in weight and thinner than CRT displays.

Conventional designs for these display devices are often difficult and awkward to position so that they may be comfortably used. Also, it is not possible to fold conventional designs into smaller, more compact units for travel or business use (moving the units from office to office, for example, for purposes of presentations and conferences).

Units which are not compact in size are also more expensive to ship and difficult to pack. Accordingly, what is needed is a system and method for offering a user the possibility of easily positioning TFT displays for comfort while at work, and which also can be easily shipped. The present invention addresses such a need.

### SUMMARY OF THE INVENTION

A display device comprising a display screen and a pivoting system coupled to the display device is disclosed. The pivoting system allows for rotation of the display screen from portrait to landscape; and for flipping the display from front to back, and for the display device to be folded into a compact form.

The design in accordance with the present invention offers a range of freedom of movement not available with previous conventional designs. In a preferred embodiment, the display device 100 can be lifted approximately 130 mm from a flat folded position. A user can rotate the display 90° degrees from portrait through landscape orientations. A user can also flip the display 180° from front to back, which will allow users on opposite sides of a desk to view the same image without turning the display around. All of these features may be used in combination, allowing the user to take advantage of multiple positioning options.

### BRIEF DESCRIPTION OF THE DRAWINGS

FIG. 1 is a perspective view of a user adjustable TFT display in accordance with the present invention.

FIG. 2 is a perspective view of a TFT display in accordance with the present invention.

FIG. 3 is a perspective view of an almost fully raised TFT display in accordance with the present invention.

FIG. 4 is a perspective view of the TFT display in accordance with the present invention.

FIG. 5 is a perspective view of the TFT display being utilized by a user in accordance with the present invention.

FIG. 6 is a perspective view flat/folded-up of the TFT display in accordance with the present invention.

### DETAILED DESCRIPTION

The present invention relates to a display device and more particularly to a display device which may be user-adjusted for height and viewing angle while also allowing the screen to be folded to a minimal height for storage and shipping purposes. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The thin film transistor (TFT) design in accordance with the present invention offers two significant advantages over conventional and previous designs. First, the design allows for the TFT display unit to be folded flat for shipping, thereby taking up approximately two-thirds less space than that of existing TFT configurations. Because TFTs are generally shipped by air, the design in accordance with the present invention offers significant shipping costs savings.

Second, the design in accordance with the present invention offers the user new ways of working, because of the flexibility of the design of the stand which supports the TFT display. The design of the stand in accordance with the present invention allows the user to set the TFT display to the viewing angle/height they prefer, depending on the nature of their work environment and the application they may be using (a graphics application may require different viewing angles and preferences than a database application, for example).

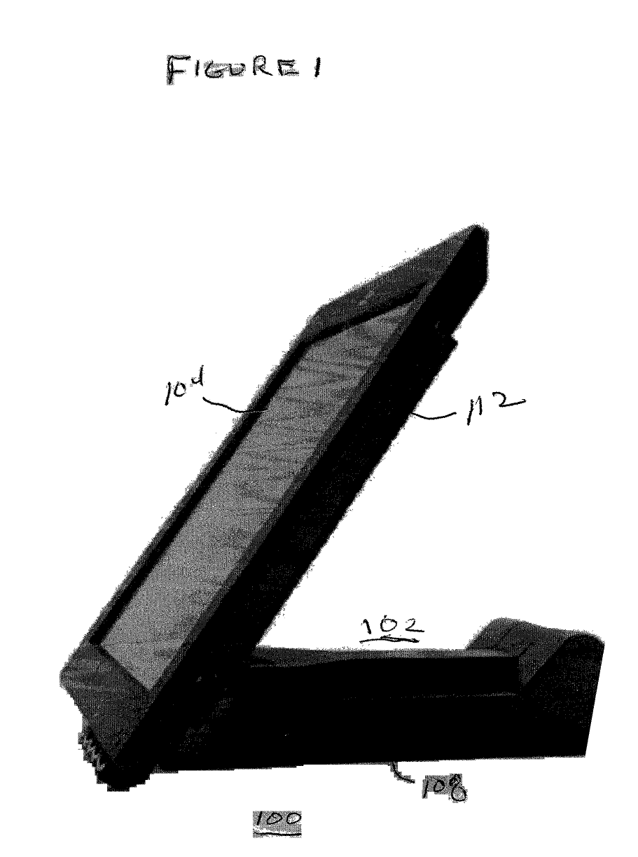

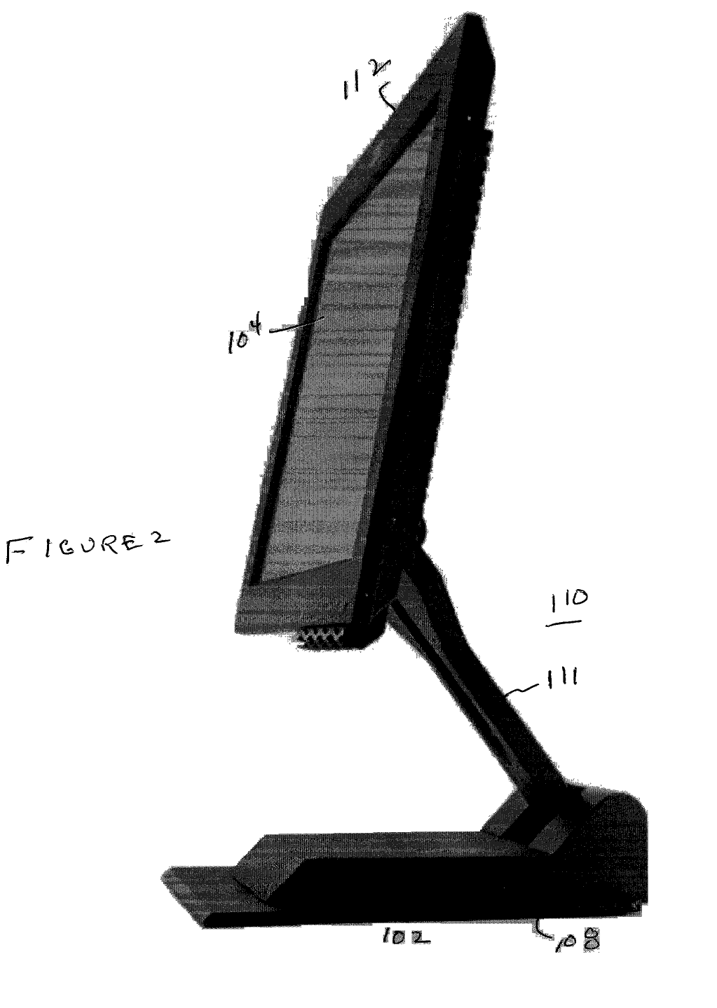

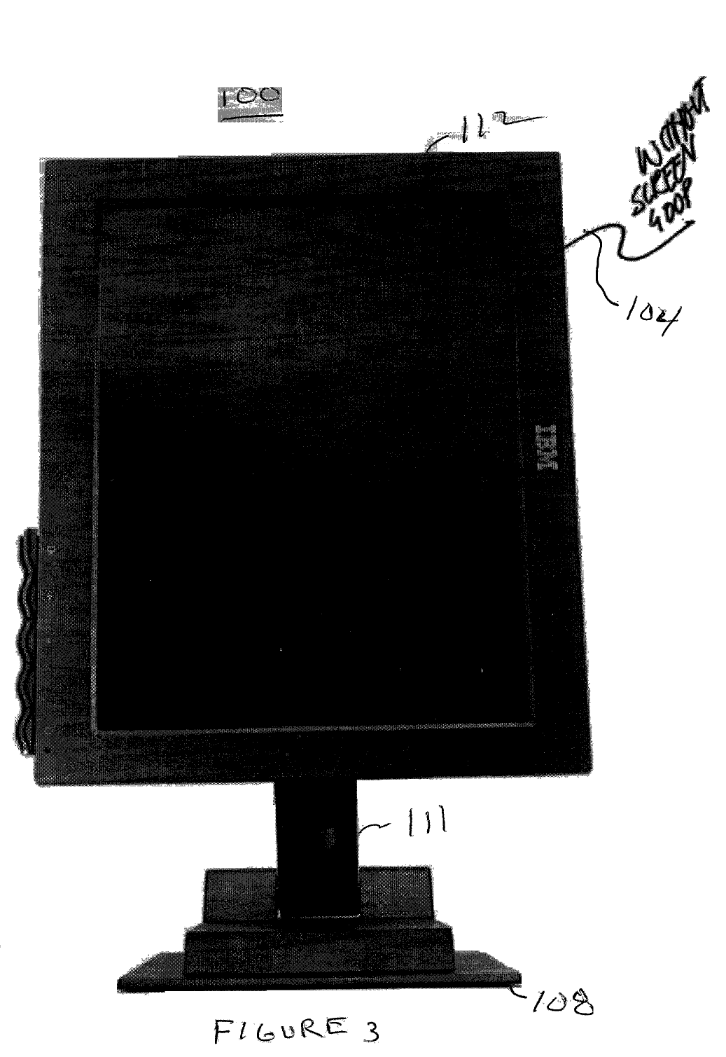

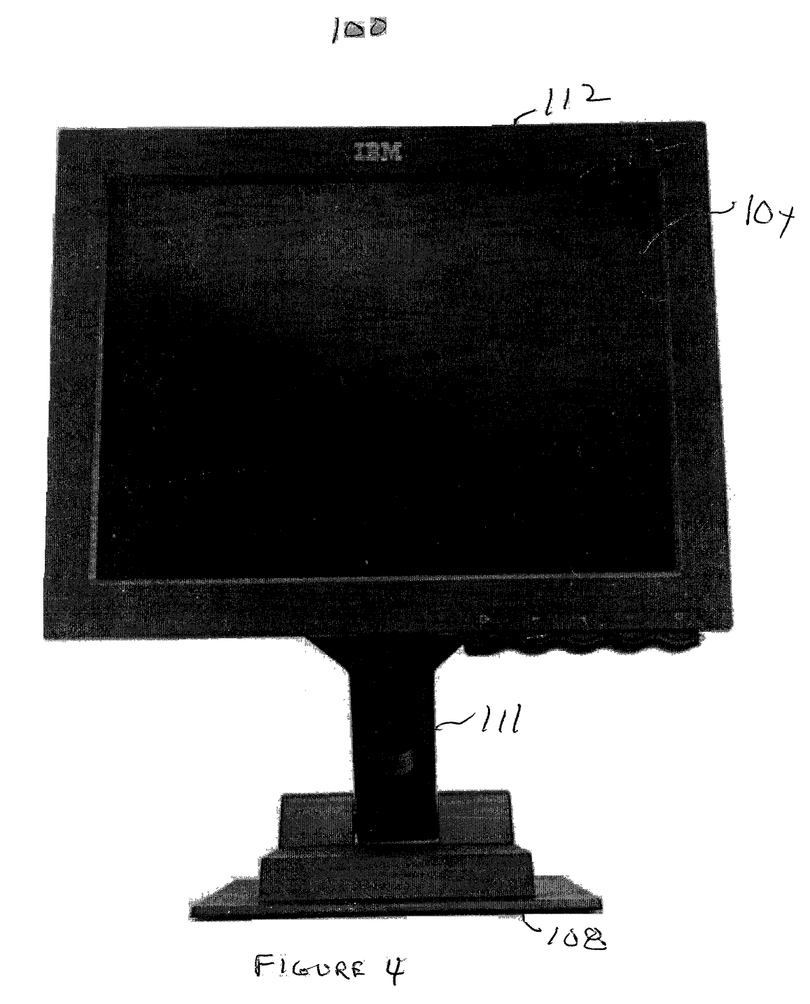

FIG. 1 is a perspective view of a preferred embodiment of a TFT display device 100 in accordance with the present invention. In this embodiment, the display device 100 comprises a pivot assembly 102 (FIG. 2) coupled to a flat screen 104. The pivot assembly enables the flat screen 104 to be adjusted for height and viewing angle while also allowing the screen to be folded to a minimum height (i.e., flat) position for storage and shipping.

FIG. 2 is a perspective view of a fully raised TFT display in accordance with the present invention. The pivot assembly 102 includes a horizontal planar base 108 and a support arm assembly 110 attached thereto. The support arm assembly 110 includes in this embodiment a support arm 111 which is attached to the base 108 and a display screen frame 112. A first end of the support arm assembly 110 is pivotally attached to a rear portion of the planar base 108, the opposing end of the support arm assembly 110 being pivotally attached to the display screen frame 112, creating a “Z” shape as the device 100 is moved to and from a stored position. The resulting “Z” shape can be seen in FIG. 2.

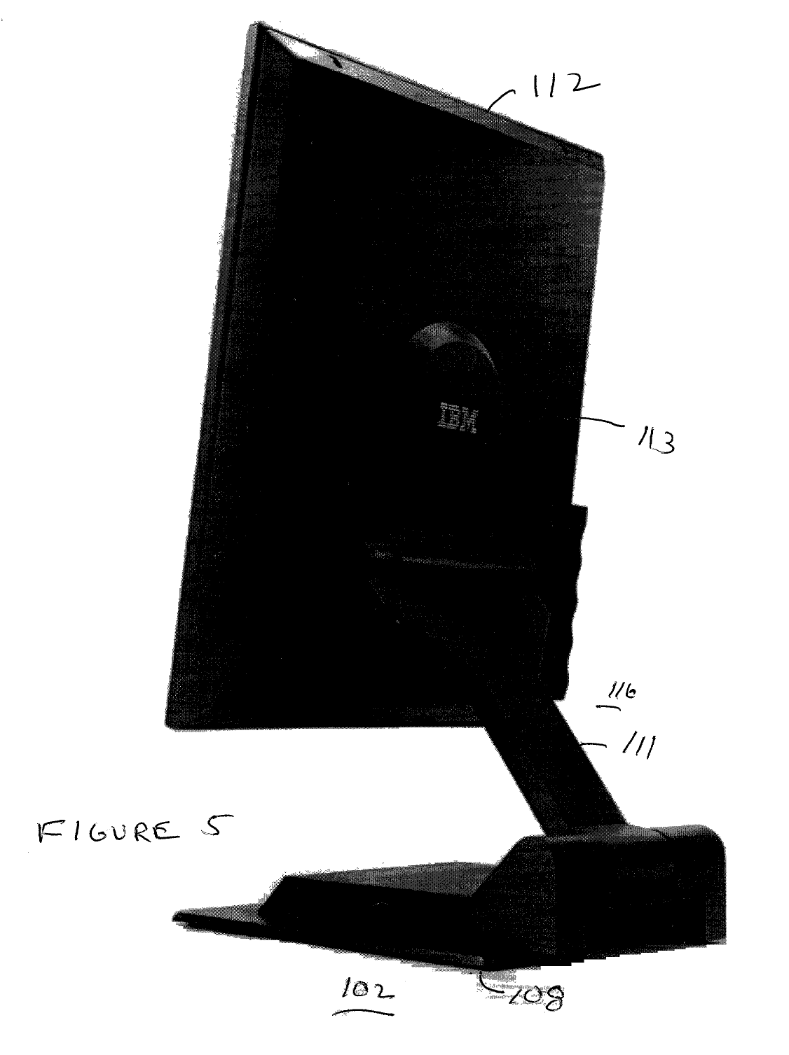

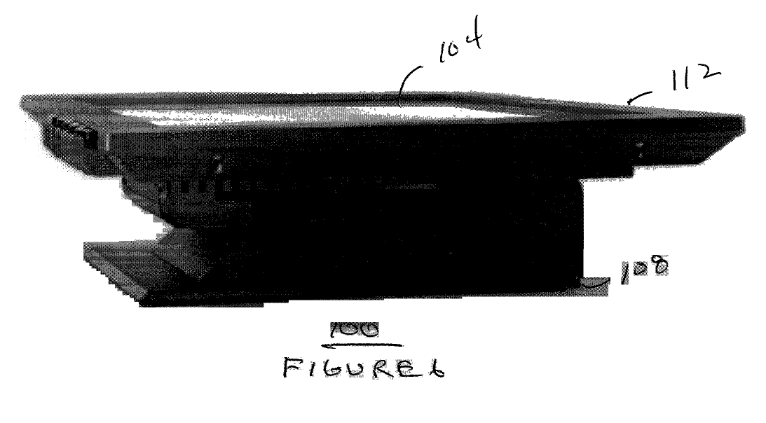

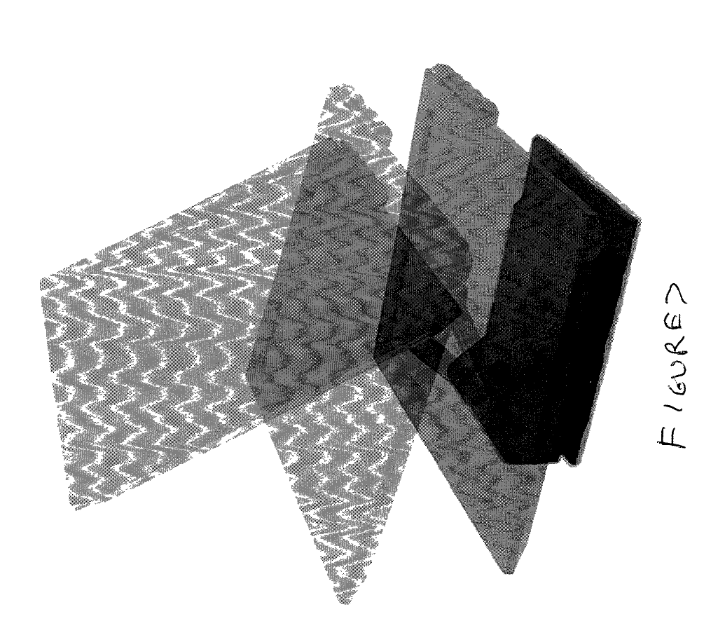

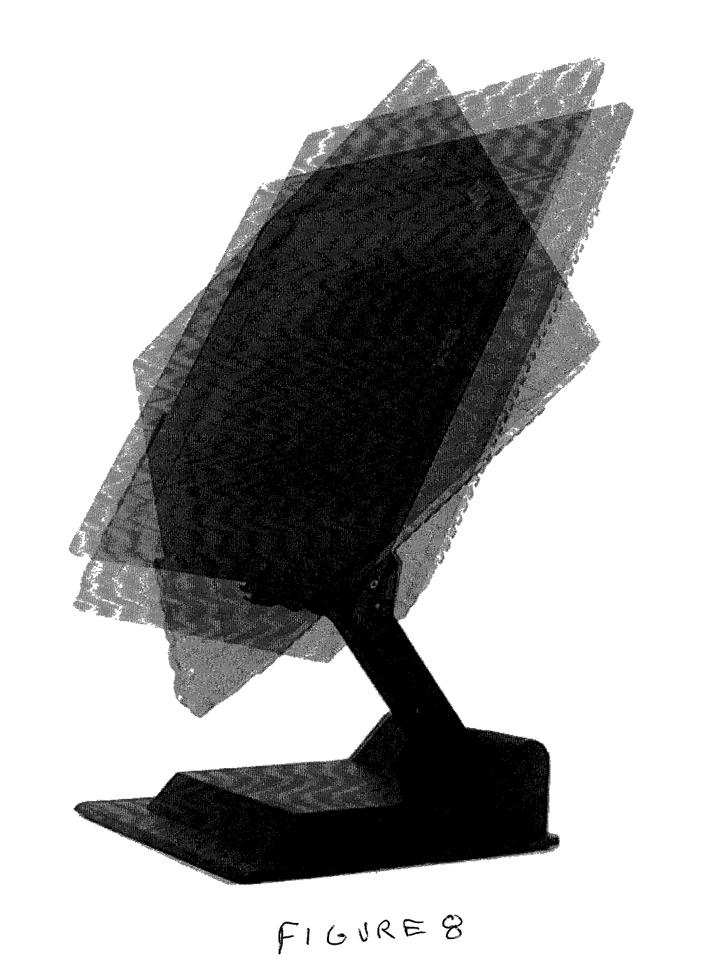

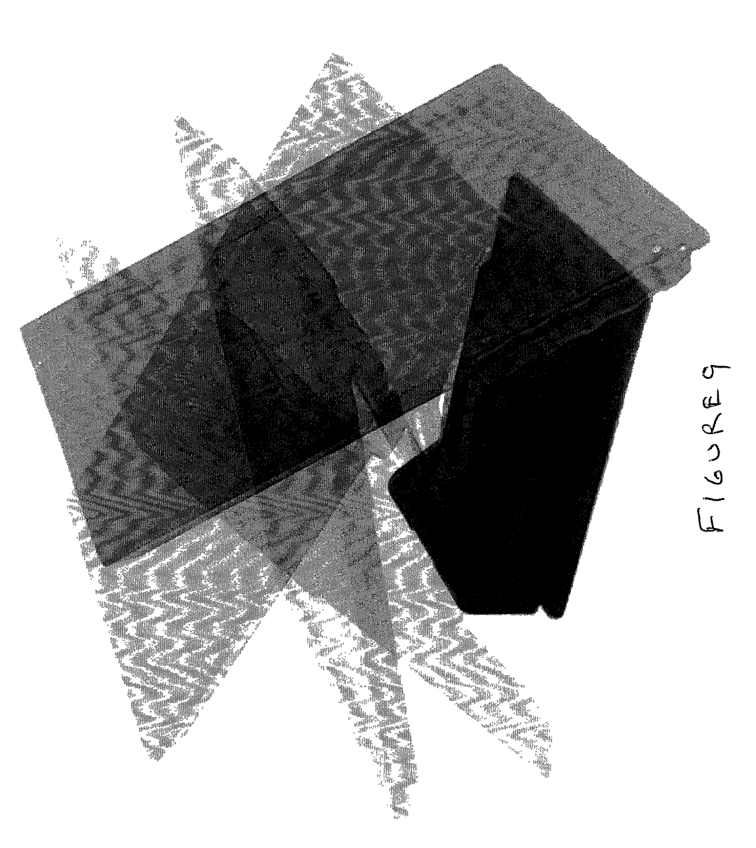

FIG. 3 is a perspective view of the back of a raised TFT display device 100 in accordance with the present invention. In this view the display device 100 is in a portrait orientation. FIG. 4 is a second perspective view of a TFT display device. In this view the display device is in a landscape orientation. FIG. 5 is a perspective view of the back of the raised TFT display device 100. As is seen, the pin 113 allows for rotation between these two orientations. Because of the flexibility of the support arm assembly 110, the user may adjust the height and angle of the screen to account for individual physical preferences, as well as preferred computer program application viewing angle, as is seen. As is also seen, the display device can flip from front to back through the movement of the display screen frame 112 via the support arm assembly 110.

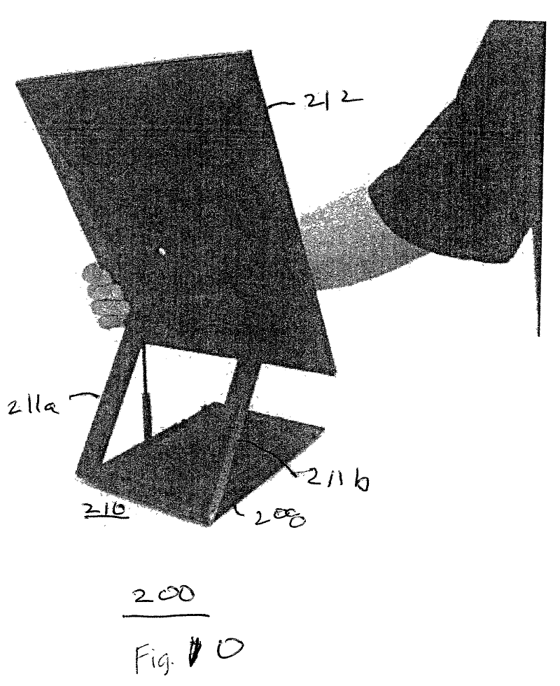

FIG. 6 is a flat/folded-up perspective view of a TFT display device 100 in accordance with the present invention. When the TFT display device 100 is folded in accordance with the present invention, packaging costs for shipping and actual shipping costs both may be significantly reduced from the costs of packaging and shipping a larger, bulkier display.

The design in accordance with the present invention offers a range of freedom of movement not available with previous conventional designs. In a preferred embodiment, the display device 100 can be lifted approximately 130 mm from a flat folded position (as shown in FIG. 7). A user can rotate the display 90° degrees from portrait through landscape orientations (as shown in FIG. 8). A user can also flip the display 180° from front to back, which will allow users on opposite sides of a desk to view the same image without turning the display around (shown in FIG. 9). All of these features may be used in combination, allowing the user to take advantage of multiple positioning options.

Although the present invention has been described in accordance with the embodiments shown, one of ordinary skill in the art will readily recognize that there could be variations to the embodiments and those variations would be within the spirit and scope of the present invention.

In addition, even though the preferred embodiment utilizes a support arm assembly that includes a single support arm, there could be variations thereto. FIG. 10 illustrates a perspective view of a second embodiment of a fully raised TFT display 200 in accordance with the present invention. In this embodiment, the support arm assembly 210 includes two substantially parallel support arms 211a and 211b which are attached to the base 108 and a display screen frame 212. A first end of the support arm assembly 210 is pivotally attached to a rear portion of the planar base 208, the opposing end of the support arm assembly 210 being pivotally attached to the display screen frame 212, creating a “Z” shape as the device 200 is moved to and from a stored position.

Finally, in another embodiment of the present invention, the TFT or LCD display device may include a “gas-charge-piston” or compression spring support assist, in order to make changing the physical configuration of the unit in a quick and easy manner. Accordingly, many modifications may be made by one of ordinary skill in the art without departing from the spirit and scope of the appended claims.

What is claimed is:

1. A display device comprising:
a display screen; and
a pivoting assembly coupled to the display screen, the pivoting assembly allowing for rotation of the display screen from portrait to landscape orientation, for flipping the display from front to back, and for the display device to be folded into a compact form.

2. The display device of claim 1 wherein the pivoting assembly includes a base portion, a support arm assembly coupled to the base portion; and a display screen frame coupled to the support arm assembly for holding the display screen.

3. The display device of claim 1 wherein the support arm assembly comprises a support arm.

4. The display device of claim 2 wherein the support arm assembly comprises first and second support arms which are disposed in a substantially parallel relationship.

5. The display device of claim 2 wherein the frame includes a pin which allows for the rotation of the display from portrait to landscape orientation.

6. The display device of claim 2 wherein the support arm assembly creates a “Z” shape as the display device is moved to and from a stored position.

7. The display device of claim 3 wherein the display screen can be rotated up to ninety (90) degrees.

8. The display device of claim 4 wherein the display screen can be rotated up to ninety (90) degrees.

9. The display device of claim 3 wherein the display screen can be flipped up to one hundred eighty (180) degrees from front to back.

10. The display device of claim 4 wherein the display screen can be flipped up to one hundred eighty (180) degrees from front to back.

11. A display device comprising:
a display screen; and
a pivoting assembly coupled to the display screen, wherein the pivoting assembly includes a base portion, a support arm assembly coupled to the base portion, and a display screen frame coupled to the support arm assembly for holding the display screen, wherein the support arm assembly comprises a support arm, wherein the frame includes a pin which allows for the rotation of the display from portrait to landscape orientation, the pivoting assembly allowing for rotation of the display screen from portrait to landscape orientation, for flipping the display from front to back, and for the display device to be folded into a compact form.

12. The display device of claim 11 wherein the support arm assembly creates a “Z” shape as the display device is moved to and from a stored position.

13. The display device of claim 11 wherein the display screen can be rotated up to ninety (90) degrees.

14. The display device of claim 11 wherein the display screen can be flipped up to one hundred eighty (180) degrees from front to back.

15. A display device comprising:
a display screen; and
a pivoting assembly coupled to the display screen, wherein the pivoting assembly includes a base portion, a support arm assembly coupled to the base portion, and a display screen frame coupled to the support arm assembly for holding the display screen, wherein the support arm assembly comprises first and second support arms which are disposed in a substantially parallel relationship, wherein the frame includes a pin which allows for the rotation of the display from portrait to landscape orientation, the pivoting assembly allowing for rotation of the display screen from portrait to landscape orientation, for flipping the display from front to back, and for the display device to be folded into a compact form.

16. The display device of claim 15 wherein the support arm assembly creates a “Z” shape as the display device is moved to and from a stored position.

17. The display device of claim 15 wherein the display screen can be rotated up to ninety (90) degrees.

18. The display device of claim 15 wherein the display screen can be flipped up to one hundred eighty (180) degrees from front to back.

19. A display device comprising:
a thin film transistor (TFT) display screen; and
a pivoting assembly coupled to the display screen, wherein the pivoting assembly includes a base portion, a support arm assembly coupled to the base portion; and a display screen frame coupled to the support arm assembly for holding the display screen, wherein the support arm assembly comprises first and second support arms which are disposed in a substantially parallel relationship, wherein the frame includes a pin which allows for the rotation of the display from portrait to landscape orientation, wherein the support arm assembly creates a “Z” shape as the display device is moved to and from a stored position, the pivoting assembly allowing for rotation of the display screen from portrait to landscape orientation; for flipping the display from front to back, and for the display device to be folded into a compact form.

20. A display device comprising:
a thin film transistor (TFT) display screen; and
a pivoting assembly coupled to the display screen, wherein the pivoting assembly includes a base portion, a support arm assembly coupled to the base portion; and a display screen frame coupled to the support arm assembly for holding the display screen, wherein the support arm assembly comprises first and second support arms which are disposed in a substantially parallel relationship, wherein the frame includes a pin which allows for the rotation of the display from portrait to landscape orientation, wherein the support arm assembly creates a “Z” shape as the display device is moved to and from a stored position, the pivoting assembly allowing for rotation of the display screen from portrait to landscape orientation; for flipping the display from front to back, and for the display device to be folded into a compact form.
